(19) United States
(12) Patent Application Publication
(10) Pub. No.: US 2010/0118335 A1
(43) Pub. Date: May 13, 2010

(54) IMAGE DISPLAY APPARATUS AND METHOD FOR CONTROLLING THE SAME

(75) Inventor: Masayuki Odagawa, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/608,882

(22) Filed: Oct. 29, 2009

(30) Foreign Application Priority Data
Nov. 7, 2008 (JP) 2008-287075

(51) Int. Cl. G06F 3/12

(52) U.S. Cl. 358/1.15

(57) ABSTRACT

An image display apparatus includes a control unit configured to display a content on a display unit, a detection unit configured to detect a printing apparatus located at a predetermined distance or less from the display unit, a calculation unit configured to calculate a position on the display unit of the printing apparatus detected by the detection unit, and a transmission unit configured to transmit, to the printing apparatus, data of a content based on the position calculated by the calculation unit among contents displayed on the display unit.

### BACKGROUND OF THE INVENTION

1. Field of the Invention

The present invention relates to an image display apparatus, and a method for controlling the image display apparatus, a program, and a storage medium, and particularly to a technique suitably used for printing displayed content.

2. Description of the Related Art

Conventionally, in printing a content displayed on a display unit, a cable or wireless connection equipment is used to connect the printer to a display unit or an information processing apparatus to which the display unit is connected. Then, after the content is selected, print is selected from the menu, a printer is selected and then, printing starts. That is, plural operations are required. To address this, for example, Japanese Patent Application Laid-Open No. 10-283067 discusses a printer-integrated electronic information apparatus that enables easy connection of the printer.

However, in the electronic information apparatus discussed in Japanese Patent Application Laid-Open No. 10-283067, printer connection is facilitated, but plural operations are still required after selection of the content. In this way, in the conventional art, the operations for printing the content displayed on the display unit are complicated and such operations become troublesome for printing many contents.

### SUMMARY OF THE INVENTION

The present invention is directed to an image display apparatus capable of eliminating or reducing complicated operations in printing a content displayed on a display unit.

According to an aspect of the present invention, an image display apparatus includes a control unit configured to display a content on a display unit, a detection unit configured to detect a printing apparatus located at a predetermined distance or less from the display unit, a calculation unit configured to calculate a position on the display unit of the printing apparatus detected by the detection unit, and a transmission unit configured to transmit, to the printing apparatus, data of a content based on the position calculated by the calculation unit among contents displayed on the display unit.

According to an exemplary embodiment of the present invention, selection of the content displayed on the display unit can be facilitated and transmission of print data can be also facilitated thereby to eliminate or reduce complicated operations.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of a configuration of an image display apparatus according to a first exemplary embodiment of the present invention.

FIG. 2 is a flowchart illustrating an example of a processing procedure for determining print data among contents in the first exemplary embodiment of the present invention.

FIG. 3 illustrates an example of a screen image displayed on a display unit when a printer is in close vicinity in the first exemplary embodiment of the present invention.

FIG. 4 is a block diagram illustrating an example of a configuration of an image display apparatus according to a second exemplary embodiment of the present invention.

### DESCRIPTION OF THE EMBODIMENTS

Various exemplary embodiments, features, and aspects of the invention will be described in detail below with reference to the drawings.

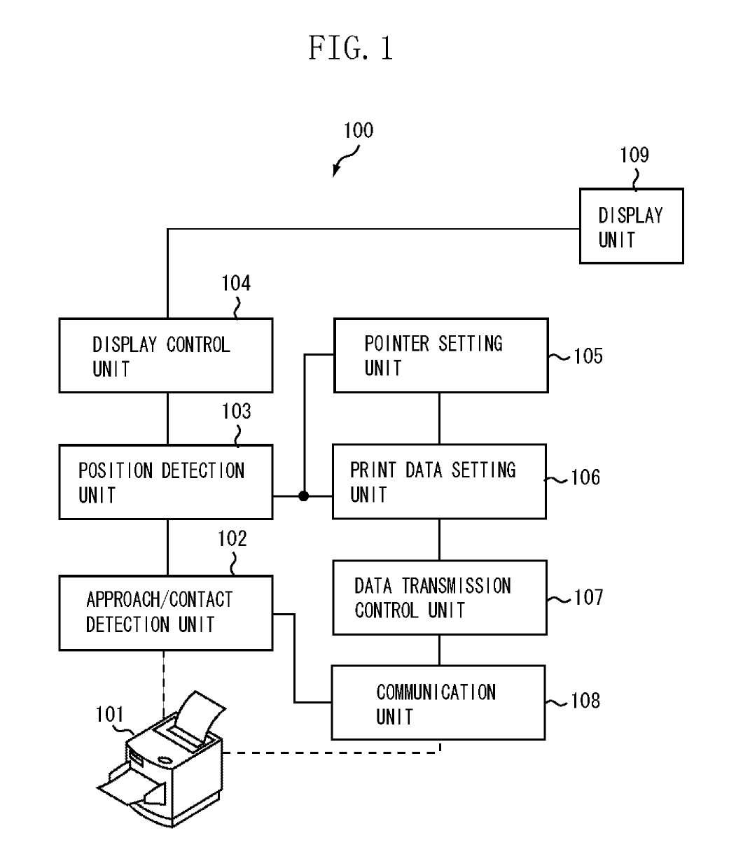

FIG. 1 is a block diagram illustrating an example of a configuration of an image display apparatus 100 according to a first exemplary embodiment of the present invention. In FIG. 1, a printer 101 as a printing apparatus is a printer, which can be brought close to a display unit 109 by a user. Hence, the printer 101 is preferably a portable, compact printer in the present exemplary embodiment.

An approach/contact detection unit 102 detects approach of the printer 101 when it is close to the display unit 109. Once the approach/contact detection unit 102 detects approach of the printer 101, it establishes connection with the printer 101 via a communication unit 108. At this time, connection with the printer 101 is performed with use of publicly known wireless communication technique.

When a position detection unit 103 receives a notice of approach of the printer 101 from the approach/contact detection unit 102, it detects an approach/contact position of the printer 101 located in the vicinity of the display unit 109. The position detection unit 103 is connected to a display control unit 104 and sends the display control unit 104 data for displaying coordinate information on a screen of the display unit 109.

The display control unit 104 displays a content on the display unit 109. The display control unit 104 is connected to the position detection unit 103 and displays the coordinate information of the printer 101 on the screen of the display unit 109.

A pointer setting unit 105 generates a pointer for selecting print data at a position where the printer 101 is in the closest vicinity of the display unit 109 so that a content can be selected. A print data setting unit 106 sets as the print data a content indicated by the pointer generated by the pointer setting unit 105. When the printer 101 goes away beyond a predetermined distance, setting is cancelled by switching. Then, when the printer 101 is brought into contact with the display unit 109 by a user, a content of a pointer at a position where the printer 101 is in contact with the display unit 109 is determined as the print data.

When the approach/contact detection unit 102 detects that the printer 101 is in contact with the display unit 109, a data transmission control unit 107 sends the print data set by the print data setting unit 106 to the printer 101 via the communication unit 108. The communication unit 108 is configured to establish wireless communication with the printer 101.

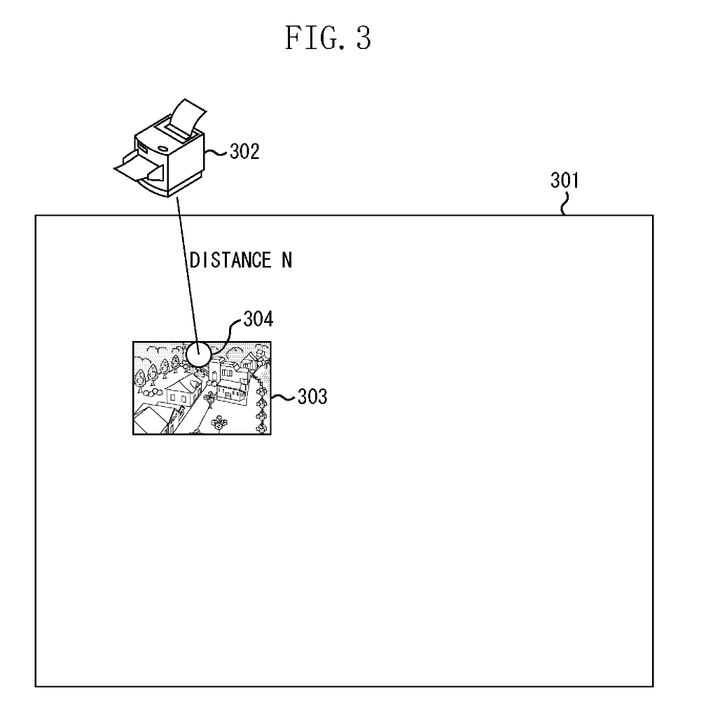

Next description is made about the operation of the present exemplary embodiment with reference to FIG. 3. FIG. 3 illustrates an example of a screen image displayed on the display unit 109 when the printer 302 is in the vicinity. In FIG. 3, a display screen 301 is displayed on the display unit 109, and a content 303 is on the display screen 301.

When the printer 302 approaches the display screen 301 and a distance between the printer 302 and the display screen 301 is N or less, the pointer setting unit 105 starts. The distance is the shortest length of a line connecting the communication unit of the printer 302 and the display screen 301. The distance between the printer 302 and the display screen 301 is detected by the approach/contact detection unit 102. Besides, a contact point of the display screen 301 with the line connecting from the display screen 301 to the communication unit of the printer 302 is an approach position of the printer 302.

When the distance from the display screen 301 is N or less, the pointer setting unit 105 sets the pointer 304 concentrically about the approach position of the printer 302 and displays it on the display screen 301 of the display unit 109. In the present exemplary embodiment, the size of the concentric circle is fixed and its diameter is of 32 pixels.

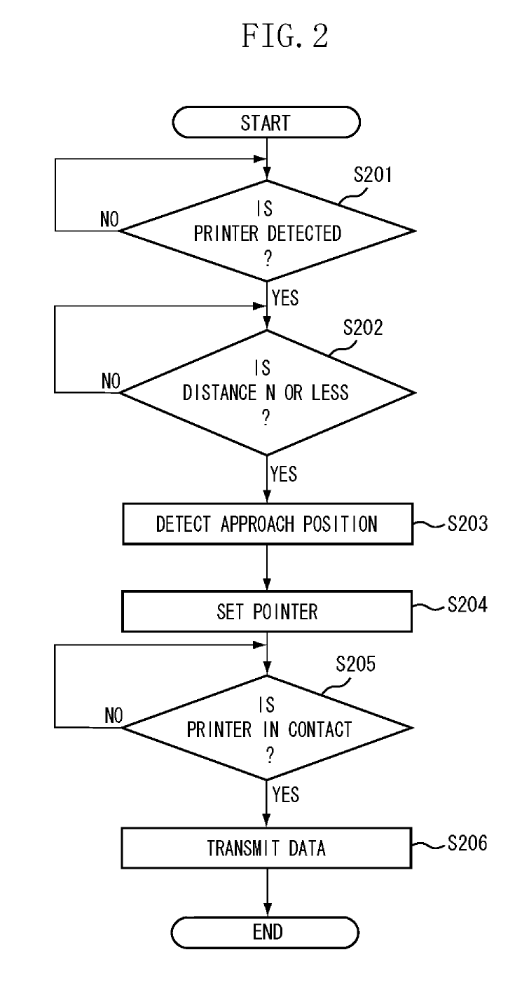

Hereinafter, the processing procedure according to the present exemplary embodiment is described with reference to the processing flow in FIG. 2. FIG. 2 is a flowchart illustrating an example of the processing procedure for determining the print data among contents in the present exemplary embodiment. First, in step S201 of FIG. 2, the approach/contact detection unit 102 always monitors approach of the printer 101 to the display unit 109 and it is determined whether it has detected approach of the printer 101. When determination results in that it does not detect approach of the printer 101, it comes into the standby state and waits for next detection. When it has detected the approach, the procedure proceeds to the next step S202.

Next in step S202, the position detection unit 103 detects a distance between the printer 101 and the display unit 109, and determines whether the distance is a predetermined distance or less (distance N in the present exemplary embodiment). When determination results in that the distance exceeds N, detection of the distance is repeated at fixed intervals and it comes into the standby state. Here, in the exemplary embodiment, an N value is fixed at 15 cm, for example. Besides, the time interval for re-detecting of the distance from the printer 101 is 0.5 seconds.

On the other hand, when the distance is N or less in step S202, then, in step S203, the position detection unit 103 detects an approach position of the printer 101. Then, instep S204, the pointer setting unit 105 sets a concentric pointer about the approach position. At this time, if there is no content at the position indicated by the pointer on the display screen on the display unit 109, position detection is repeated at fixed intervals. On the other hand, when there is a content at the position indicated by the pointer, the print data setting unit 106 sets the content indicated by the pointer as the print data.

Next, in step S205, it is determined whether the approach/contact detection unit 102 has detected the printer 101 is in contact. When this determination results in that the contact is not detected, it comes into the standby state. When contact is further detected, the procedure proceeds to step S206. Then, in step S206, the data transmission control unit 107 receives from the print data setting unit 106 content information set as the print data and transmits the content data to the printer 101 via the communication unit 108. Then, the processing ends.

As described in detail above, the image display apparatus 100 according to the present exemplary embodiment, content selection and printing can be made by approaching or contact of the printer. With this configuration, the content can be printed without complicated operations. The exemplary embodiment has been described by way of the example where the operation of content selection and print data transmission is performed by approach and contact of the printer main body. However, the operation may be performed by approach and contact of a separatable part of the printer without losing any effect of the present invention.

The first exemplary embodiment has been described by way of an example where the content indicated by the pointer is set as the print data and the print data is sent to the printer in response to contact of the printer . In a second embodiment of the present invention, a print range of the content displayed on the display unit 109 is set.

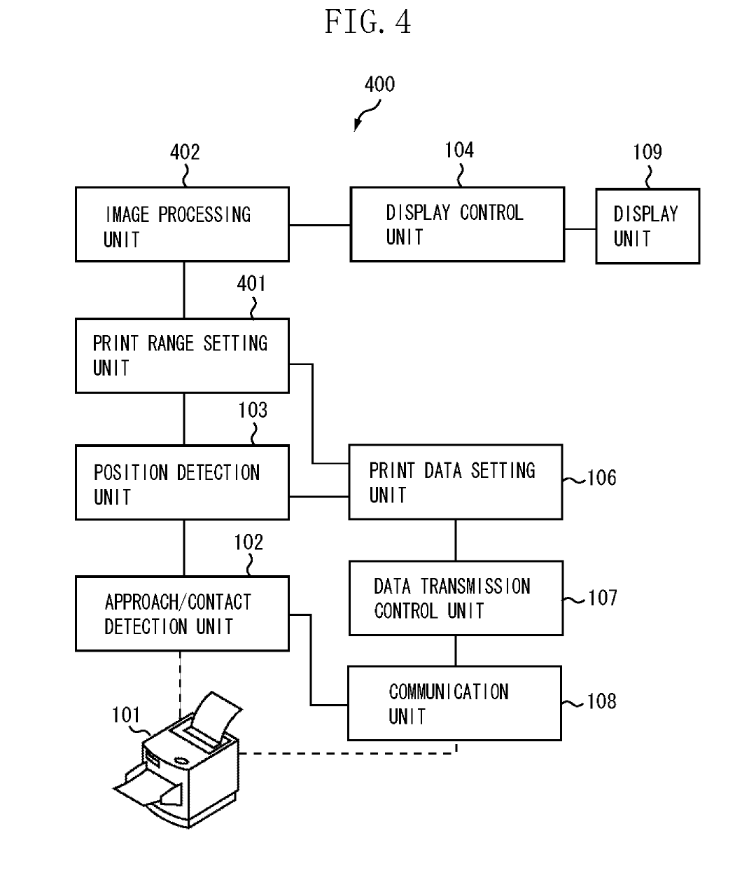

FIG. 4 is a block diagram illustrating an example of a configuration of an image display apparatus 400 according to the second exemplary embodiment. Regarding overlapping components between FIGS. 1 and 4, they are similar to those in the first exemplary embodiment, description thereof will not be repeated. When the position of the printer 101 is detected by a position detection unit 103, a print range setting unit 401 sets a content of a predetermined area at the position where the printer 101 is in the closest vicinity of the display unit 109. The print data setting unit 106 then sets as a printing area the area to be printed. The range of the area set can be determined via an operating unit (not shown) by a user.

In response to contact of the printer 101 with the display unit 109, an image processing unit 402 generates print data at the printing area set by the print data setting unit 106, and the data transmission control unit 107 transmits the generated print data to the printer 101.

As described above, according to the present exemplary embodiment, setting of the printing area of the content and printing can be made by approach and contact of the printer. With this configuration, the content printing can be made without the complicated operations.

The present invention may be applied to a part of a system including plural apparatuses or to apart of an apparatus of one equipment. The present invention is not limited to the apparatus and method for embodying the above exemplary embodiments. For example, the present invention includes a unit for supplying a program code of software for embodying the above exemplary embodiment to a computer (central processing unit (CPU) or microprocessing unit (MPU)) in the above apparatus.

It also includes a case where the above-described exemplary embodiments are embodied by a computer of the apparatus that makes various devices operate according to the program code.

In this case, the program code of the software itself executes the functions of the above-described exemplary embodiments. In other words, the program code itself, and the unit for supplying the program code to a computer, or specifically, a computer-readable storage medium storing the program code, fall within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-287075 filed Nov. 7, 2008, which is hereby incorporated by reference herein in its entirety.

What is claimed is:

1. An image display apparatus comprising:
a control unit configured to display a content on a display unit;
a detection unit configured to detect a printing apparatus located at a predetermined distance or less from the display unit;
a calculation unit configured to calculate a position on the display unit of the printing apparatus detected by the detection unit; and
a transmission unit configured to transmit, to the printing apparatus, data of a content based on the position calculated by the calculation unit among contents displayed on the display unit.

2. The image display apparatus according to claim 1, further comprising a print data setting unit configured to switch between setting and canceling of a content to be printed based on a distance between the printing apparatus and the position of the content displayed on the display unit.

3. The image display apparatus according to claim 1, wherein the detection unit detects contact with the printing apparatus, and
wherein in response to the contact with the printing apparatus, the transmission unit transmits data of the content to the printing apparatus.

4. The image display apparatus according to claim 1, further comprising a print range setting unit configured to set a print range of the content displayed on the display unit, based on the position calculated by the calculation unit,
wherein the transmission unit transmits, to the printing apparatus, data of the content within the print range set by the print range setting unit.

5. A method for controlling an image display apparatus, the method comprising:
displaying a content on a display unit;
detecting a printing apparatus located at a predetermined distance or less from the display unit;
calculating a position on the display unit of the printing apparatus detected; and
transmitting, to the printing apparatus, data of a content based on the calculated position among contents displayed on the display unit.

6. The method according to claim 5, further comprising switching between setting and canceling of a content to be printed based on a distance between the printing apparatus and the position of the content displayed on the display unit.

7. The method according to claim 5, further comprising:
detecting contact with the printing apparatus; and
transmitting, to the printing apparatus, data of the content in response to the contact with the printing apparatus.

8. The method according to claim 5, further comprising:
setting a print range of the content displayed on the display unit, based on the calculated position; and
transmitting, to the printing apparatus, data of the content within the set print range.

9. A computer-readable storage medium storing a computer program for causing a computer to execute a method comprising:
displaying a content on a display unit;
detecting a printing apparatus located at a predetermined distance or less from the display unit;
calculating a position on the display unit of the printing apparatus detected; and
transmitting, to the printing apparatus, data of a content based on the calculated position among contents displayed on the display unit.
